(19) United States
(12) Patent Application Publication
(10) Pub. No.: US 2007/0215750 A1
(43) Pub. Date: Sep. 20, 2007

(54) Radio controlled helicopter

(76) Inventors: Michael Shantz, Cupertino, CA (US); Matthew Keennon, Simi Valley, CA (US)

Correspondence Address: MCDERMOTT WILL & EMERY LLP, 600 13TH STREET, N.W., WASHINGTON, DC, 20005-3096, US

(21) Appl. No.: 11/599,615

(22) Filed: Nov. 15, 2006

Related U.S. Application Data
(60) Provisional application No. 60/737,807, filed on Nov. 18, 2005.

(51) Int. Cl. B64C 27/08

(52) U.S. Cl. 244/17.23

(57) ABSTRACT

A radio controlled helicopter is provided which eliminates or simplifies forward/reverse flight control for safe and easy indoor operation. Embodiments include a helicopter having a pair of counter rotating rotors which are driven at the same speed, a vertically aligned tail rotor driven by a reversible motor for controlling yaw, and a mass, such as a power supply battery, mounted for changing the center of gravity of the helicopter to adjust the tendency of the helicopter to move in a forward or reverse direction. The mass is either rigidly mounted, so that the helicopter is always moving forward during flight, or adjustably mounted so that the helicopter's forward or reverse direction can be adjusted prior to or during flight. A protective cage is provided to protect persons from injury from the rotors and to prevent damage to the rotors due to contact with objects during flight.

### CROSS REFERENCE TO RELATED APPLICATION

This application claims priority under 35 U.S.C. §119 from Provisional Patent Application No. 60/737,807, filed on Nov. 18, 2005. The entire subject matter of the application is incorporated herein by reference.

### FIELD OF THE INVENTION

The present invention relates to helicopters. The present invention has particular applicability in radio controlled helicopters which can be flown indoors.

### BACKGROUND ART

Radio controlled helicopters present operating difficulties related to coordination of directional flight controls, due to a multiplicity of such controls. Typically, the pilot must simultaneously operate four controls: altitude (ascent/descent), heading (forward/reverse), rotation (left/right) and side to side movement or “sideslip” (left/right). In an attempt to effectively control the flight path, the pilot of a radio controlled helicopter can easily become confused, or can cross control the aircraft, resulting in a collision.

A known design for a radio controlled helicopter that is relatively simple to operate features counter rotating propellers (also called rotors). This design is inherently stable. Steering is typically accomplished by varying the relative rotational speeds of the counter rotating rotors. When the speeds of the rotors are not equal, the helicopter will steer left or right depending on which rotor is rotating faster. Although this design improves the stability of the helicopter, it is mechanically complex, usually requiring two motors (one for each rotor). Such complexity is disadvantageous because it adds cost and weight to the helicopter.

Another disadvantage of conventional radio controlled helicopters is that they are not practical to use indoors, such as in a relatively small living space, because their rotor(s) are easily damaged during a collision with a wall or ceiling. Moreover, persons in the room can be injured by the rotor(s).

There exists a need for a radio controlled helicopter design that is easy to fly, simple and inexpensive. There also exists a need for a radio controlled helicopter that can be safely flown indoors.

### SUMMARY OF THE INVENTION

An advantage of the present invention is the elimination of one set of helicopter flight controls, so that even an inexperienced pilot can satisfactorily fly the inventive helicopter with minimal risk of collision.

A further advantage of the present invention is in the ability to operate the inventive helicopter safely indoors.

Additional advantages and other features of the present invention will be set forth in part in the description which follows and in part will become apparent to those having ordinary skill in the art upon examination of the following or may be learned from the practice of the invention. The advantages of the invention may be realized and obtained as particularly pointed out in the appended claims.

According to the present invention, the foregoing and other advantages are achieved in part by a helicopter comprising a body, a first rotor, a propulsion unit substantially rigidly attached to the body and having a first shaft for mounting and rotatably driving the first rotor, and a mass adjustably mounted to the body for changing a center of gravity of the helicopter.

In another aspect of the present invention, the helicopter comprises a rotor protector to protect persons from injury from the first rotor and to prevent damage to the first rotor due to contact with objects during flight. The rotor protector comprises a support tube rotatably mounted over the first shaft; a safety ring having a diameter greater than that of the first rotor and supported by the support tube such that it is substantially level with the first rotor; and a tether for flexibly attaching the rotor protector to a tail of the helicopter for preventing the rotor protector from spinning.

A still further aspect of the present invention is a helicopter comprising a body; a first rotor; a second rotor; a propulsion unit substantially rigidly attached to the body, the propulsion unit having a propulsion motor, a first drive shaft attached to the motor for mounting and rotatably driving the first rotor, and a second drive shaft coaxial to the first shaft and attached to the motor, for mounting and rotatably driving the second rotor in an opposite direction to the first rotor at substantially the same speed as the first rotor; a substantially vertically aligned tail rotor for controlling yaw of the helicopter during flight, the tail rotor having a plane of rotation intersecting a center of mass of the helicopter and being disposed a predetermined distance from the center of mass of the helicopter; a reversible motor for rotating the tail rotor; and a mass rigidly mounted to the body such that a center of gravity of the helicopter is forward of the first and second drive shafts.

A still further aspect of the present invention is a rotor protector to protect persons from injury from the first and second rotors and to prevent damage to the rotors due to contact with objects during flight. The rotor protector comprises a support tube rotatably mounted over the first or second shaft between the first and second rotors, a first safety ring having a diameter greater than that of the first rotor, a second safety ring having a diameter greater than that of the second rotor, a plurality of spokes extending radially outward from the support tube, and a plurality of rods, each rod attached to one of the spokes and to the first and second safety rings. The rods support the safety rings such that the first safety ring is substantially level with the first rotor, and the second safety ring is substantially level with the second rotor. A tether is provided for flexibly attaching the rotor protector to a tail of the helicopter for preventing the rotor protector from spinning.

Additional advantages of the present invention will become readily apparent to those skilled in this art from the following detailed description, wherein only the preferred embodiment of the present invention is shown and described, simply by way of illustration of the best mode contemplated for carrying out the present invention. As will be realized, the present invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIG. 1 is a perspective view of a helicopter in accordance with an embodiment of the present invention.

FIG. 2 is a side view of the helicopter of FIG. 1.

### DESCRIPTION OF THE INVENTION

The present invention provides an easily operated radio controlled helicopter, by eliminating or simplifying the sideslip flight control. In an embodiment of the present invention; a forward directional flight path is achieved by placing the center of gravity of the helicopter forward of the center of lift (i.e., the center of the rotor(s)) by locating the power supply battery in a forward area of the helicopter fuselage. The result is a helicopter which is always moving forward and inherently stable. The pilot need only be concerned with power, which controls altitude and descent, and with left/right steering, which is effected through a conventional tail rotor that controls yaw.

In certain embodiments of the present invention, a helicopter comprises two counter rotating rotors which are driven by a single motor at a fixed 1:1 relative rotation speed. The forward speed of the inventive helicopter can be adjusted by manual movement of the battery relative to the forward end of the fuselage. The further forward the battery is placed in the fuselage, the faster the forward speed of the helicopter, and vice versa. In other embodiments of the present invention, an actuator is provided for moving the battery by remote control during flight. Thus, the operator can control forward or reverse motion of the craft; for example, by the push of a button, to shift the weight inside the helicopter to effect the desired forward or reverse motion.

The present invention further provides a helicopter which is safe to operate indoors. In one embodiment, an impact ring is provided around each rotor to prevent the helicopter from harming persons nearby, and to prevent damage to the rotor blades. The impact rings can comprise light weight carbon fiber rod or fiberglass rod, and are supported by a number of spokes equally spaced around the radius of the rings. The spokes are connected to a hub located around the main shaft for driving the rotor blades. The two rings are positioned in parallel planes and are spaced in the rotation plane of each rotor blade. The rings are connected to each other to form a rigid protective framework around the blades.

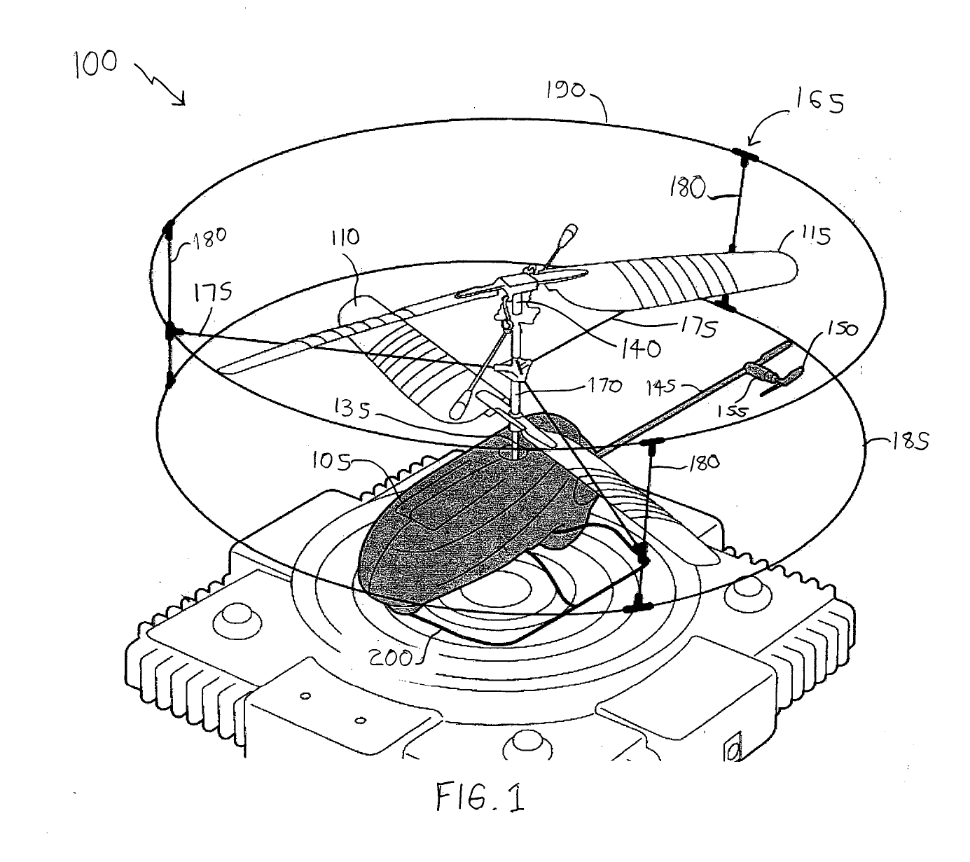

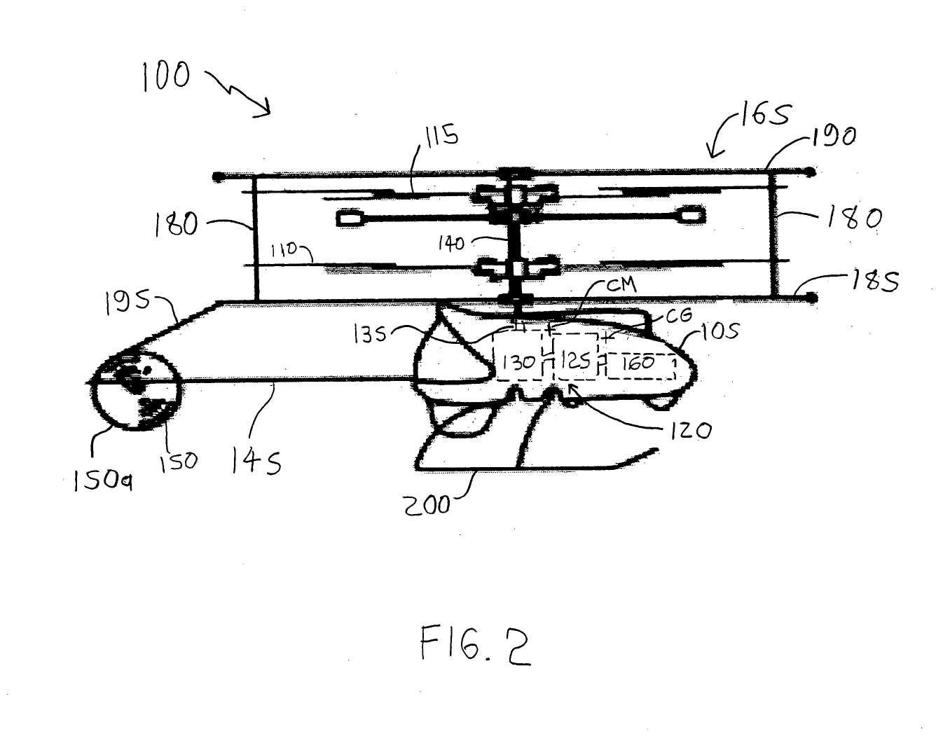

Referring to FIGS. 1-2, a helicopter according to an embodiment of the present invention will now be described. A helicopter 100 generally comprises a body 105, a first rotor 110, a second rotor 115, and a propulsion unit 120 substantially rigidly attached to body 105. Total flying weight of helicopter 100 is a maximum of 23 grams. Weight should be kept to a minimum, because extra weight requires a significant increase in power, as motors and rotors are less efficient as they lift more weight.

Propulsion unit 120 has a propulsion motor 125, a transmission 130, a first drive shaft 135 for mounting and rotatably driving first rotor 110, and a second drive shaft 140 coaxial to first drive shaft 135 for mounting and rotatably driving second rotor 115 in an opposite direction to first rotor 110 at substantially the same speed as first rotor 110. Propulsion motor 125 is a conventional iron core, brushed motor; e.g., weighing about 3.6 grams and having a terminal resistance of 1.0-1.5 Ohm. Motor 125 is capable of proportional speeds, with 100 steps for control. Transmission 130 and drive shafts 135, 140 are of a conventional design.

First and second rotors 110, 115 each have a pair of blades and a hub. The blades must be very close to each other in weight, thickness, shape, curvature and twist to minimize unwanted vibration. Blades that are used together on a single rotor must be mass balanced. The rotor blades are fixed on their hubs and do not pivot. The blades can be made to snap into and out of place, but must hold their position precisely.

Helicopter 100 has a tail boom 145 comprising, for example, extruded plastic soda straw tubing or carbon fiber tubing, and a substantially vertically aligned tail rotor 150 for controlling yaw of helicopter 100 during flight. Tail rotor 150 has a plane of rotation intersecting a center of mass CM of helicopter 100, and is disposed a predetermined distance from center of mass CM. Center of mass CM is slightly forward of drive shafts 135, 140 and centered left to right, such that when held by the top of drive shaft 140, helicopter 100 tilts forward a few degrees, and less than one degree left or right. A reversible motor 155 is provided for rotating tail rotor 150. Motor 155 is a conventional coreless, brushed, vibrator-type motor; e.g., about 4 mm in diameter, 8 mm in length, and having about 10-15 Ohm terminal resistance. Motor 155 is capable of proportional speeds, such as 50 steps forward and 50 steps reverse, for control.

Tail rotor 150 is a simple propeller with thin blades and sharp edges, such as an injection molded plastic propeller having a knife edge all around. The blades of tail rotor 150 are substantially flat plates with sharp edges set at angles in a conventional manner such that it can push air in a first direction and in an opposing direction (depending on the direction it is driven). A fixed ring 150a can be provided around tail rotor 150 (see FIG. 2), such as a lightweight injection molded plastic ring with about a 4 mm clearance gap beyond the tips of tail rotor 150.

A battery 160 for providing electrical power to motors 125 and 150 is rigidly mounted to body 105 and acts as a mass to cause a center of gravity CG of helicopter 100 to be forward of the first and second drive shafts 135, 140. Battery 160 can be a conventional lithium polymer rechargeable battery, such as a single 145 mAhr battery available from Kokam of Kyunggi-do, Korea.

A conventional remote controller (not shown) controls a speed and rotational direction of reversible tail rotor motor 150 and controls a speed of propulsion unit motor 125.

Helicopter 100 further includes a rotor protector 165 to protect persons from injury from first and second rotors 110, 115, and to prevent damage to the rotors due to contact with objects during flight. Rotor protector 165 further serves to increase helicopter 100's moment of inertia, thereby reducing the tendency for the helicopter to rotate undesirably in yaw, and smoothing out desired yaw commands. Rotor protector 165 comprises a support tube 170 rotatably mounted over the first or second drive shaft 135, 140 between first and second rotors 110, 115. A plurality of spokes 175, such as three spokes, extend radially outward from support tube 170 and are substantially parallel to first and second rotors 110, 115. Spokes 175 are vertically spaced to be about halfway between contacting parts of first and second rotors 110, 115. A substantially vertical rod 180 is attached to a tip of each one of the spokes 175 and to first and second safety rings 185, 190.

Rods 180 support safety rings 185, 190 such that they remain in a substantially circular shape centered on the drive shafts 135, 140; and such that first safety ring 185 is substantially level with the tips of the first rotor 110, and second safety ring 190 is substantially level with the tips of the second rotor 115. Rotor protector 165 further includes a tether 195 for flexibly attaching rotor protector 165 to tail boom 145 for preventing rotor protector 165 from spinning. Tether 195 can be a flexible wire, tube or cord which attaches first safety ring 185 to tail boom 145 without imparting torque to the bushing surfaces of support tube 170.

Safety rings 185, 190 each have a diameter greater than that of their associated rotor; e.g., to allow a gap of about 10 mm between the tip of the respective rotor blade and the ring. Safety rings 185, 190, spokes 175 and rods 180 are made from 0.20 to 0.28 mm diameter fiberglass or carbon fiber. Alternatively, safety rings 185, 190 can be about 1 mm diameter extruded plastic tubing having a thin wall, similar to a soda straw.

Landing legs 200 are provided to support body 105 such that when power is turned off and helicopter 100 falls straight down from 12 feet, landing legs 200 are not damaged. Landing legs 200 are of a simple post/tube construction extending downward from the bottom of body 105 near the drive shafts 135, 140, and are constructed using curved, small diameter soda straw extruded plastic tubing. They are attached to body 105 to provide some shock absorbing action, and not to be rigid.

Another embodiment of the present invention will now be described. This embodiment is substantially identical to the previously described embodiment of FIGS. 1-2, except that the rigidly mounted battery 160 is replaced by an adjustably mounted battery that is manually adjustable before and after flight. The battery is mounted such that its fore/aft position along the center line of body 205 can be changed, thereby shifting the center of gravity CG fore or aft as desired and adjusting the forward speed of the helicopter.

In certain other embodiments of the present invention, the battery is mounted in the body such that it can be manually moved left to right, thereby shifting the center of gravity CG left or right to adjust the tendency of the helicopter to translate left or right.

A further embodiment of the present invention will now be described, which is substantially identical to the previously described embodiment of FIGS. 1-2, except that the rigidly mounted battery 160 is replaced by an adjustably mounted battery that is adjustable during flight. The battery is mounted such that its fore/aft position along the center line of the body can be changed during flight via a conventional remote controller which controls an actuator, thereby shifting the center of gravity CG fore or aft as desired and adjusting the forward speed of the helicopter. In one embodiment of the present invention, the remote controller has a button which causes the actuator to move the battery from a first position where center of gravity CG of the helicopter is forward of drive shafts 135, 140 and the helicopter flies forward, to a second position where center of gravity CG is behind drive shafts 135, 140 and the helicopter flies in reverse. Thus, the pilot controls the forward/reverse direction of the helicopter by the push of a button.

In certain other embodiments of the present invention, a battery is mounted such that its left/right position along the center line of the body can be changed during flight via a conventional remote controller which controls an actuator, thereby shifting the center of gravity CG left or right as desired and adjusting the tendency of the helicopter to translate left or right.

The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without resorting to the details specifically set forth. In other instances, well known processing structures have not been described in detail, in order not to unnecessarily obscure the present invention.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

What is claimed is:

1. A helicopter comprising:
a body;
a first rotor;
a propulsion unit substantially rigidly attached to the body and having a first shaft for mounting and rotatably driving the first rotor; and
a mass adjustably mounted to the body for changing a center of gravity of the helicopter.

2. The helicopter of claim 1, wherein the mass is movable during flight towards and away from a forward end of the body to alter a tendency of the helicopter to move in a forward or a reverse direction.

3. The helicopter of claim 2, further comprising an actuator for moving the mass during flight, and a remote controller for controlling the actuator to move the mass.

4. The helicopter of claim 1, wherein the mass is movable during flight transverse to a longitudinal axis of the body to alter a tendency of the helicopter to translate left or translate right.

5. The helicopter of claim 4, further comprising an actuator for moving the mass during flight, and a remote controller for controlling the actuator to move the mass.

6. The helicopter of claim 1, having a rotor protector to protect persons from injury from the first rotor and to prevent damage to the first rotor due to contact with objects during flight, the rotor protector comprising:
a support tube rotatably mounted over the first shaft;
a safety ring having a diameter greater than that of the first rotor and supported by the support tube such that it is substantially level with the first rotor; and
a tether for flexibly attaching the rotor protector to a tail of the helicopter for preventing the rotor protector from spinning.

7. The helicopter of claim 6, comprising:
a plurality of spokes extending radially outward from the support tube; and
a plurality of rods, each rod attached to one of the spokes and to the safety ring, for supporting the safety ring such that the safety ring is substantially level with the first rotor.

8. The helicopter of claim 1, wherein the mass comprises a battery for providing electricity to the propulsion unit.

9. The helicopter of claim 1, further comprising a second rotor, wherein the propulsion unit has a second shaft coaxial to the first shaft for mounting and rotatably driving the second rotor in an opposite direction to the first rotor at substantially the same speed as the first rotor.

10. The helicopter of claim 9, wherein the propulsion unit comprises a single electric motor.

11. The helicopter of claim 9, wherein the first rotor has a first set of blades, and the second rotor has a second set of blades, and the second set of blades have a size and shape that substantially mirror a size and shape of the first set of blades, such that the first and second rotors have substantially matching aerodynamic lift, aerodynamic drag and mass properties when the rotors are rotated in opposite directions by the propulsion unit.

12. The helicopter of claim 9, further comprising a substantially vertically aligned tail rotor for controlling yaw of the helicopter during flight, the tail rotor having a plane of rotation intersecting a center of mass of the helicopter and being disposed a predetermined distance from the center of mass of the helicopter.

13. The helicopter of claim 12, further comprising a reversible motor for rotating the tail rotor, and a remote controller for controlling a speed and rotational direction of the motor during flight.

14. The helicopter of claim 12, wherein the tail rotor comprises a set of blades and a fixed ring around the blades to protect persons from injury from the tail rotor and to prevent damage to the tail rotor due to contact with objects during flight.

15. The helicopter of claim 9, having a rotor protector to protect persons from injury from the first and second rotors and to prevent damage to the rotors due to contact with objects during flight, the rotor protector comprising:
a support tube rotatably mounted over the first or second shaft between the first and second rotors;
a first safety ring having a diameter greater than that of the first rotor and supported by the support tube such that it is substantially level with the first rotor;
a second safety ring having a diameter greater than that of the second rotor and supported by the support tube such that it is substantially level with the second rotor; and
a tether for flexibly attaching the rotor protector to a tail of the helicopter for preventing the rotor protector from spinning.

16. The helicopter of claim 15, comprising:
a plurality of spokes extending radially outward from the support tube; and
a plurality of rods, each rod attached to one of the spokes and to the first and second safety rings, for supporting the safety rings such that the first safety ring is substantially level with the first rotor, and the second safety ring is substantially level with the second rotor.

17. The helicopter of claim 16, wherein the safety rings comprise fiberglass.

18. The helicopter of claim 16, wherein the spokes and rods comprise carbon fiber.

19. A helicopter comprising:
a body;
a first rotor;
a second rotor;
a propulsion unit substantially rigidly attached to the body, the propulsion unit having a propulsion motor, a first drive shaft attached to the motor for mounting and rotatably driving the first rotor, and a second drive shaft coaxial to the first shaft and attached to the motor, for mounting and rotatably driving the second rotor in an opposite direction to the first rotor at substantially the same speed as the first rotor;
a substantially vertically aligned tail rotor for controlling yaw of the helicopter during flight, the tail rotor having a plane of rotation intersecting a center of mass of the helicopter and being disposed a predetermined distance from the center of mass of the helicopter;
a reversible motor for rotating the tail rotor; and
a mass rigidly mounted to the body such that a center of gravity of the helicopter is forward of the first and second drive shafts.

20. The helicopter of claim 19, having a rotor protector to protect persons from injury from the first and second rotors and to prevent damage to the rotors due to contact with objects during flight, the rotor protector comprising:
a support tube rotatably mounted over the first or second shaft between the first and second rotors;
a first safety ring having a diameter greater than that of the first rotor;
a second safety ring having a diameter greater than that of the second rotor;
a plurality of spokes extending radially outward from the support tube and substantially parallel to the first and second rotors;
a plurality of rods, each rod attached to one of the spokes and to the first and second safety rings, for supporting the safety rings such that the first safety ring is substantially level with the first rotor, and the second safety ring is substantially level with the second rotor; and
a tether for flexibly attaching the rotor protector to a tail of the helicopter for preventing the rotor protector from spinning.

21. A rotor protector for a helicopter having a rotor and a shaft for mounting and rotatably driving the rotor, the rotor protector being for protecting persons from injury from a rotor of the helicopter and for preventing damage to the rotor due to contact with objects during flight, the rotor protector comprising:
a support tube rotatably mounted over the shaft;
a safety ring having a diameter greater than that of the rotor and supported by the support tube such that it is substantially level with the rotor; and
a tether for flexibly attaching the rotor protector to a tail of the helicopter for preventing the rotor protector from spinning.
